(19) United States
(12) Patent Application Publication
(10) Pub. No.: US 2008/0036827 A1
(43) Pub. Date: Feb. 14, 2008

(54) Facade for an Ink Tank

(76) Inventors: James Daniel Anderson, Harrodsburg, KY (US); Jay Scott Siekmann, Nicholasville, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/422,609

(22) Filed: Jun. 7, 2006

(51) Int. Cl. B41J 2/175

(52) U.S. Cl. 347/86

(57) ABSTRACT

A fluid reservoir is disclosed that includes a facade that attaches to an ink tank body and has a distinctive color, curvature and/or keying function that prevents the reservoir from being improperly inserted into a printing device. Further, a method of mounting a RFID tag is described that includes, in some embodiments, the use of the facade cavity as a secure location for the RFID tag.

### FIELD OF THE INVENTION

The present invention generally relates to printing systems. More particularly, the present invention relates to a tank that contains ink and has a facade that performs at least one of several functions.

### BACKGROUND OF THE INVENTION

Micro-fluid ejection heads are useful for ejecting a variety of fluids including inks, cooling fluids, pharmaceuticals, lubricants and the like. A widely used micro-fluid ejection head is in an ink jet printer. Ink jet printers continue to be improved as the technology for making the micro-fluid ejection heads continues to advance. New techniques are constantly being developed to provide low cost, highly reliable printers which approach the speed and quality of laser printers. An added benefit of ink jet printers is that color images can be produced at a fraction of the cost of laser printers with as good or better quality than laser printers. All of the foregoing benefits exhibited by ink jet printers have also increased the competitiveness of suppliers to provide comparable printers and supplies for such printers in a more cost efficient manner than their competitors.

Micro-fluid ejection devices may be provided with permanent, semi-permanent, or replaceable ejection heads (sometimes referred to herein as a “printhead”). Since the ejection heads require unique and relatively costly manufacturing techniques, some ejection devices are provided with permanent or semi-permanent ejection heads. Such ejection heads are connected to removable fluid supply cartridges that contain the fluid or fluids being ejected. In order to control ejection of the fluids, the cartridges may be provided with a negative pressure inducing device within a fluid cavity of the cartridge. Such negative pressure inducing devices include, but are not limited to, felt blocks, foam blocks, and other porous materials that may be saturated with the fluid and have capillaries or pores that induce a negative pressure in the cavity. The permanent or semi-permanent ejection head may also include a wicking projection that contacts the negative pressure inducing device.

When a printhead is included on the ink container, the container is typically referred to has an ink cartridge. In contrast, when a printer has a permanent or semi-permanent ejection head, the ink container does not include a printhead and is typically referred to as an ink tank. The printhead is typically the most electrically complex, and correspondingly, the most expensive component of the ink cartridge. Because this component is absent in the ink tank, an ink tank is typically less expensive to manufacture than an ink cartridge. Thus, when examining the cost of ink supplies, the printer equipped with a permanent or semi-permanent printhead that uses ink tanks is oftentimes considered more economically desirable that the printer that requires ink cartridges.

A potential downside to having a permanent or semi-permanent printhead on a printer is the need to make sure that the printhead is not damaged or otherwise rendered unusable as ink tanks are changed. Damage can occur, for example, if the printhead is left exposed to the air too long a period of time causing the liquid interface to dry out. Another potential problem is the possibility of cross contamination of inks. Color printers use three or more different colors of inks, and a semi-permanent printhead can be damaged if the wrong color of ink is allowed to contaminate a printhead ink path. A number of different approaches have been adopted by printer manufacturers to prevent damage to a printhead caused by misinstallation of an ink tank.

A need exists in the industry for improved fluid containers that address this and other problems that are known in the art.

### BRIEF DESCRIPTION OF THE DRAWINGS

FIG. 1 is a top perspective view, not to scale, of a tank body and facade attachment in accordance with an embodiment of the present invention;

FIG. 2 is a bottom perspective view, not to scale, of the tank body in accordance with an embodiment of the present invention.

FIG. 3 is a cross-sectional view, not to scale, of a fluid supply container containing a negative pressure inducing device therein and a portion of a micro-fluid ejection head structure for connection to the fluid supply cartridge;

FIG. 4 is a top perspective view, not to scale, of a tank body and facade attachment in accordance with an embodiment of the present invention.

FIG. 5 is a top end view of four fluid reservoirs aligned adjacent one another in accordance with an embodiment of the present invention.

FIG. 6 is a cross-sectional side view of an ink tank being inserted into a printer in accordance with an embodiment of the present invention.

FIG. 7A is a top perspective view of a radio frequency identifier (RFID) tag and an embodiment of a facade.

FIG. 7B is a cross-sectional side view of a RFID tag inserted into a facade cavity in accordance with an embodiment of the present invention.

FIG. 8 is a top perspective of a RFID tag being inserted into an ink tank in accordance with an embodiment of the present invention.

FIG. 9 is a top perspective view of a RFID tag being inserted into an ink tank in accordance with another embodiment of the present invention.

The embodiments set forth in the drawings are intended to be illustrative and are not intended to limit the invention as defined by the claims. Further, individual features of the drawings and invention will be more fully apparent and understood in view of the detailed description and the known prior art.

### SUMMARY OF THE INVENTION

A fluid reservoir is disclosed that includes a facade that attaches to an ink tank body and has a distinctive color, curvature and/or keying function that prevents the reservoir from being improperly inserted into a printing device. Further, a method of mounting a RFID tag is described that includes, in some embodiments, the use of the facade cavity as a secure location for the RFID tag.

A fluid reservoir is described that includes a body having a liquid compartment and a negative pressure inducing cavity separated by a partition, the negative pressure producing cavity including a negative pressure inducing material disposed in the cavity, and a facade connected to said body. In some described embodiments, the facade has a distinctive shape that corresponds to a shape of a receiving member of a printing device. In some embodiments, the facade additionally includes one or both or a tank mount and a keying slot.

Various versions of a fluidic reservoir are described in which the facade is distinct from the rigid body that constitutes the ink tank body. While in other embodiments, the facade cavity is created by an additional partition will in the ink tank body. In some embodiments, the ink tank body includes two portions: a liquid compartment and a negative pressure inducing cavity. In other embodiments, the ink tank body includes a third portion, that of the facade cavity.

Also described herein are methods of mounting a RFID tag in an ink supply component. In some described embodiments, the RFID tag is inserted into a separate facade component that is then attached to the ink tank body. In some embodiments, the RFID tag is inserted into the facade cavity from the bottom, in others the insertion is from the top. In still other embodiments, the RFID tag is inserted into an extra pocket in an ink tank body that is separated from the other tank body chambers by a partition.

### DETAILED DESCRIPTION OF THE INVENTION

Reference is now made in detail to various embodiments of the invention, examples of which are illustrated in the accompanying drawings, wherein like numerals indicate similar elements throughout the views.

For the purposes of this disclosure, a wide variety of negative pressure including devices may be used provided the device is in intimate contact with a fluid outlet wick when a fluid supply cartridge is attached to a micro-fluid ejection head structure. Such negative pressure inducing devices include, but are not limited to, open cell foams, capillary containing materials, absorbent materials, and the like.

As used herein, the terms “foam” and “felt” will be understood to refer generally to reticulated or open cell foams having interconnected void spaces, i.e., porosity and permeability, of desired configuration which enable a fluid to be retained within the foam or felt and to flow therethrough at a desired rate for delivery to a micro-fluid ejection head. Foams and felts of this type are well known in the art. A commercially available example of a suitable foam is a felted open cell foam which is a polyurethane material made by the polymerization of a polyol and toluene diisocyanate. The resulting foam is a compressed, reticulated flexible polyester foam made by compressing a foam with both pressure and heat to specified thickness.

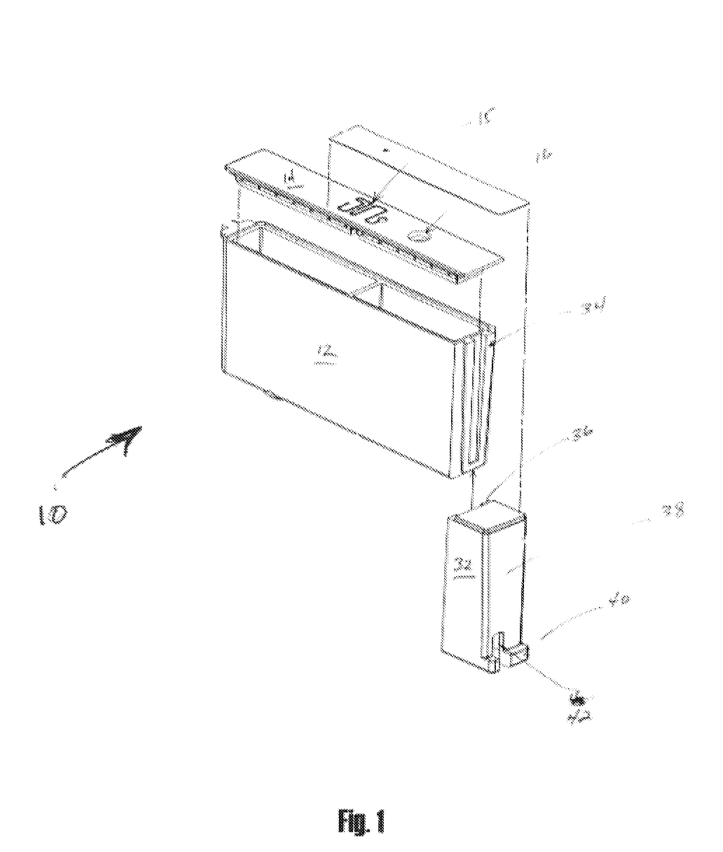

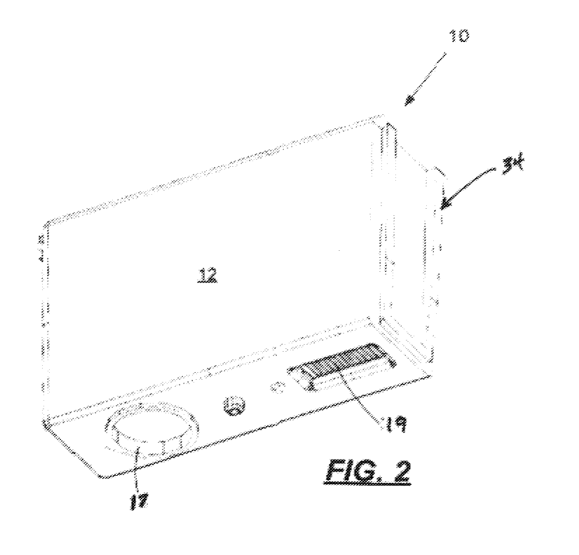

With reference to FIG. 1 and FIG. 2, perspective views of a fluid supply container 10 are illustrated. The fluid reservoir 10 has two primary portions. The first portion includes a rigid body 12 and a lid 14 attached to the body 12. The lid 14 may include an inlet port 16 for filling or refilling the body 12 with fluid such as ink and an air vent 15. The second portion is a facade 32 structure that will be described in greater detail below.

A bottom perspective view of the body 10 is provided in FIG. 2. A fluid outlet port 17 is provided for flow of fluid out of the fluid reservoir 10 to a micro-fluid ejection head structure. The fluid reservoir 10 may include a substantially transparent panel 19 for detecting a liquid presence or liquid level in the fluid reservoir 10.

The rigid body 12 and lid 14 may be made of a variety of materials including, but not limited to, metals, plastics, ceramics, and the like, provided they are made of materials compatible with the fluids they contain. In that regard, a polymeric material that may be used to provide the body 12 and cover 14 may be selected from the group consisting of an amorphous thermoplastic polyetherimide available from G.E. Plastics of Huntersville, N.C., a glass gilled thermoplastic polyethylene terephthalate resin available for E. I. du Pont de Nemours and Company of Wilmington, Del., a syndiotactic polystyrene containing glass fiber available from Dow Chemical Company of Midland, Mich., a polyphenylene oxide/high impact polystyrene resin blend available from G.E. Plastics, and a polyamide/polyphenylene ether resin available from G.E. Plastics.

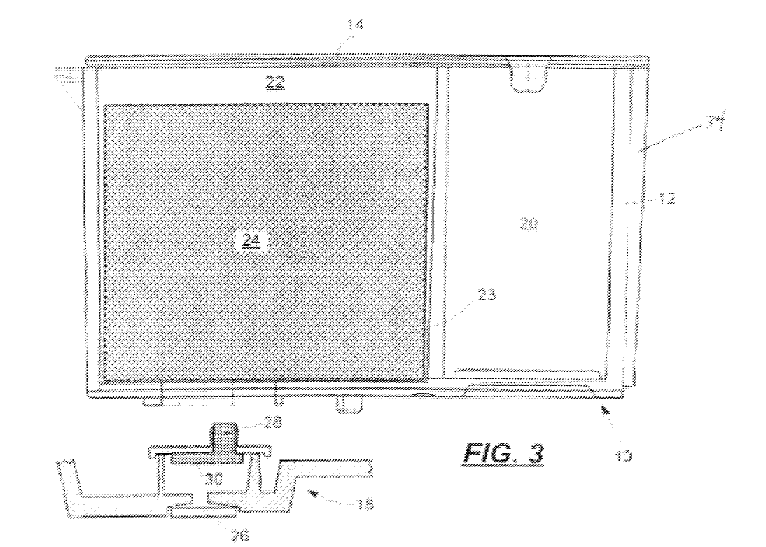

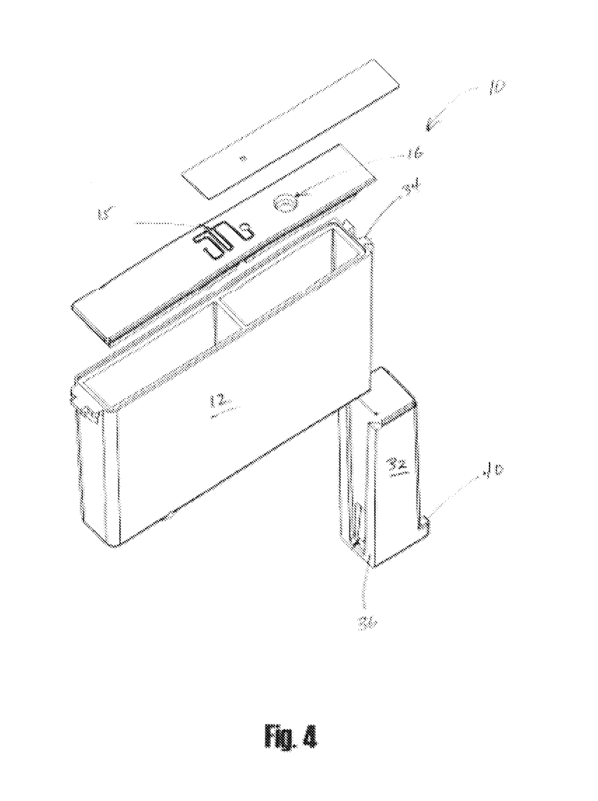

A cross-sectional view of the fluid reservoir 10 and an exemplary ejection head structure 18 are illustrated in FIG. 3. As shown, the fluid reservoir 10 includes a liquid compartment 20, a negative pressure inducing cavity 22, and a fluid flow opening 23 connecting the liquid compartment 20 with the negative pressure inducing cavity 22. The negative pressure inducing cavity 22 contains a negative pressure inducing device 24 such as a felted foam, described above. When the fluid reservoir 10 is operatively connected in fluid flow communication with the ejection head structure 18, fluid from the negative pressure inducing cavity 22 is caused to flow into the ejection head structure 18 for controlled ejection of fluid, such as ink, onto a fluid receptive media. In that regard, the ejection head structure includes a micro-fluid ejection head 26 attached thereto. A wick/filter structure 28/30 provides contact with the negative pressure inducing device 24 when the fluid reservoir 10 is attached to the ejection head structure 18. Intimate contact between the wick 28 and the negative pressure inducing device 24 allows fluid to flow to the ejection head structure 18 from the fluid reservoir 10.

With reference again to FIG. 1, a facade 32 is illustrated that attaches to container body 12 via an interlocking interface between body ribs 34 and facade ribs 36. In the illustrated embodiment, body ribs 34 are formed in a U-shape with a taper at the curved portion of the body rib 34 at the bottom of reservoir 10. Facade ribs 36 interacts with the corresponding body ribs 34 to lock the facade 32 to the reservoir 10 as the facade is attached to the body 12 via an upward motion. These attachment features are advantageous in that they can be molded with simple open-close molds and do not require slides or lifters in the manufacturing tooling. But one of ordinary skill will recognize that other attachment features can be used to attache the facade 32 to body 12.

In the illustrated embodiment, facade 32 includes a curbed face 38 opposite the facade ribs 36 and one or both of a tank mount rib 40 and keying slot 42 cut into the tank mount rib 40 and curved face 38. Tank mount ribs 40 work in conjunction with structural features on the body 12 and printer carrier to hold the fluid reservoir 10 in place such that the required fluidic interface between the wick 28 and negative pressure inducing device 24 exists when fluidic reservoir 10 is properly positioned within printer.

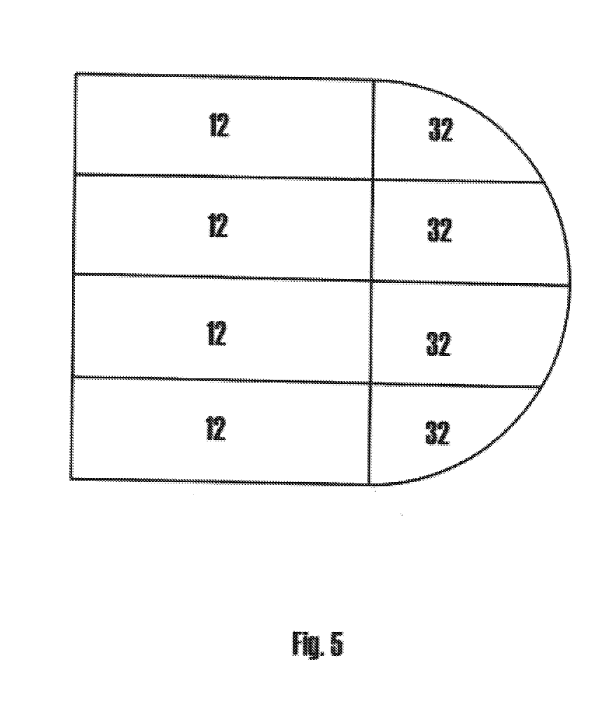

In some embodiments, a plurality of fluidic reservoirs 10, such as, for example, four or more, are used in a single printing device. Each of the fluidic reservoirs 10 can contain a different color of ink, such as black, cyan, magenta and yellow. To insure that each of the fluidic reservoirs 10 are properly positioned in the printer, the fluidic reservoir 10 containing each of the different colors of ink may have a unique curvature. FIG. 5 shows an exemplary embodiment in which the curvatures of four fluidic reservoirs 10 create a semi-circle, approximately 180° are, when each of the four reservoirs 10 is disposed adjacent one another. In this embodiment, the structure in the printer that receives the four fluidic reservoirs 10 would be configured to receive the semi-circular shape. A benefit of such a configuration is that any one of the fluidic reservoirs 10 fits only that location intended for that reservoir 10. If a user mistakenly attempted to place a fluidic reservoir 10 in a different location, the reservoir 10 would not fit because the curvature of the reservoir 10 would not match the corresponding curvature of the printer structure that holds the reservoirs. An advantage of having each reservoir 10 fit in only one location is that it prevents cross-contamination of a permanent or semi-permanent printhead. Because a fluidic reservoir 10 that contains a first ink color cannot fit into a location intended for a fluidic reservoir 10 of a different color, the possibility of cross-contamination of a printhead resulting from reservoirs 10 being improperly loaded into a printer is eliminated.

In FIG. 5, the shape of the fluidic reservoirs 10 is determined by the shape of the facade 32. Having the shape of the fluidic reservoir 10 be determined by the facade 32 allows the rigid body 12 to be of a common shape and size for each of the different types of fluidic reservoirs 10. Such an approach simplifies the manufacturing process in that a single rigid body 12 can be used to hold more that one ink color. Of course, one of ordinary skill in the art will readily recognize that this approach is not essential to the invention. In fact, in some embodiments, the rigid body 12 and facade 32 are not even separate structures. For example, in some embodiments, the structure referenced herein as a facade 32 can be a portion of the rigid body 12 that is separated from the liquid compartment 20 by a partition wall. In such an embodiment, the rigid body 12 would contain three compartments: a liquid compartment 20, a negative pressure producing cavity 22 and a facade compartment, all three disposed within the walls of body 12.

Although the figures and much of the narrative herein described a fluidic reservoir 10 with a free ink region or liquid compartment, one of ordinary skill in the art will readily recognize that some embodiments of the present invention can comprise a fluidic reservoir 10 with just a negative pressure inducing cavity and facade. The facade may be a separate piece that attaches to the body that forms the negative pressure inducing cavity or, alternatively, the negative pressure inducing cavity and facade may be formed in a single unitary body such that the facade cavity and negative pressure inducing cavity are separated by an internal wall or partition that seals the facade cavity from the negative pressure inducing cavity. In this latter embodiment, of course, the unitary body may itself have a distinctive curvature or other distinctive shape, or at least may have one wall with a distinctive shape that corresponds to a shape of a reservoir receiving member of a printing device.

One of ordinary skill in the art will readily recognize that the semi-circular curvature illustrated in FIG. 5 is not the only structural design that can be used with the present invention. In other embodiments, any curvature of other structural angles can be used so long as each of the plurality of fluidic reservoirs 10 has a unique shape that prevents a user from misloading a fluidic reservoir 10. Further, the shape of the facade 32, or the shape of the rigid body 12, is not necessarily the only design factor to prevent misloading a reservoir 10. In additional embodiments, the keying slot 42 can be configured so that it is unique to the receiving structure on the printer. Thus, in cases where multiple reservoirs 10 are used in a single printer, each reservoir 10 may have a unique key slot 42 that prevents a fluidic reservoir 10 from being loaded into the wrong location. In some embodiments, a fluidic reservoir 10 may use both a unique shape and unique key slot 42 to prevent misloading, while in alternative embodiments only one or the other are used. And as before, the key slot 42 may be a part of the facade 32, or may be part of the rigid body 12.

As described above, the shape of the facade 32 is curbed to match the curvature of the printer's carrier, or such other structure in the printer that receives the reservoirs 10. The curvature provides a visual indication of the correct orientation of the reservoir 10 in the printer. If the facade 32 is an add-on piece to the body 12 (as opposed to being integral to the body 12), changing the industrial design of the facade 32 allows the shape of the reservoir 10 to be readily modified with minimum impact of the manufacturing assembly of the equipment and ink filling equipment, which rely upon the standard design of the rigid body 12.

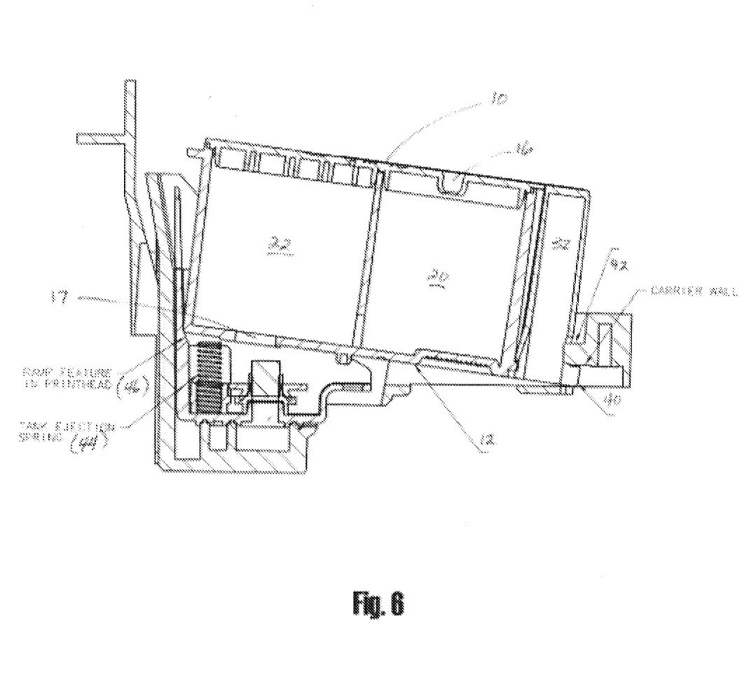

FIG. 6 illustrates an interaction between a fluid reservoir 10 and a printer carrier in accordance with an illustrative embodiment of the present invention. This illustration shows a facade 32 attached to a rigid body 12 to form a fluid reservoir 10. A tank mount rib 40 fits underneath the carrier wall as the reservoir 10 is latched in place. In this illustration, the printhead assembly has a spring 44 and a ramp feature 46 at the front of the carrier. During the installation of the fluid reservoir 10, the reservoir 10 drops down into the carrier and rests on the bottom rear of the face 32 and spring 44. As the reservoir 10 is pushed in a downward motion, it contacts the ramp 46 in the front of the printhead, which causes the reservoir 10 to slide toward the rear, moving the tank mount rib 40 under the carrier wall and securing the reservoir 10 in place.

An aspect of some embodiments of the present invention is an apparatus and methods of mounting a radio frequency identifier (RFID) tag 50 to a tank. RFID tags 50 are known in the art and can perform a number of functions when used with an ink jet printer system. In accordance with some embodiments of the present invention, the facade 32 serves an additional function of holding a RFID tag 50 in a secure position that is protected from the environment outside the fluidic reservoir 10.

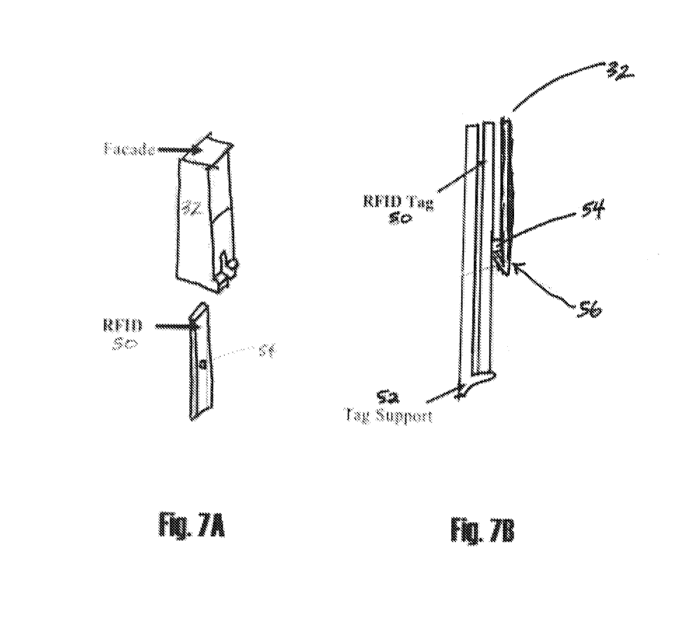

FIG. 7A shows a RFID tag 50 and facade 32, and FIG. 7B shows a cross-sectional view indicating how an RFID tag 50 can be placed in a cavity within the facade 32. As shown in the figure, a tag support member 52 is disposed within the facade cavity and serves as a base upon which an RFID tag 50 can rest. As is known in the art, a RFID tag 50 typically has a semiconductor chip with RF circuits, logic and memory disposed on the chip substrate. The chip and/or substrate is encapsulated or laminated to protect it from the environment. In FIG. 7A, an encapsulated semiconductor chip 54 is shown on the RFID tag 50 and the facade cavity includes a RFID tag slot 56 that receives the RFID tag substrate and secures the RFID tag 50 in the facade 32. In this illustration, the RFID tag 50 is inserted into the facade 32 from the bottom. As the RFID tag 50 travels upward, the RFID tag substrate presses against a ramped portion of the tag support member 52 of the interior cavity of the facade, forcing it outwards until the RFID tag substrate rests on support member 52.

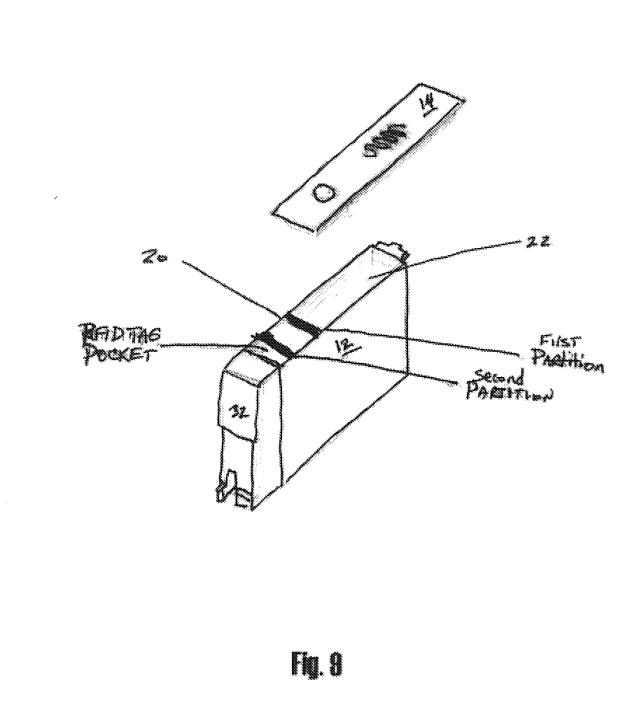

FIG. 8 illustrates an alternative method of mounting in which an RFID tag 50 is inserted into a face 32 from the top. In this example, the top of the facade 32 is initially left open, allowing the RFID tag 50 to slide into the cavity from the opened top. Once the tag 50 is properly secured and oriented within the face cavity, a lid 14, that extends over the rigid body 12 and facade 32, is attached (via methods that are known in the art) to cover both.

FIG. 9 illustrates still another alterative embodiment in which the RFID tag 50 is contained within an internal RFID tag cavity 60 that is distinct from the chambers in the rigid body 12 and from the facade 32. A lid 14 that extends over the liquid compartment 20, negative pressure inducing cavity 22 and tag cavity 60 is attached to cover each.

Following from the above description and invention summaries, it will be readily apparent to one of ordinary skill in the art that, while the methods and apparatuses herein described constitute exemplary embodiments of the present invention, the invention contained herein is not limited to these precise embodiments and that changes may be made to the embodiments without departing from the intent and scope of the invention as defined by the claims. Further, it is understood that the invention is defined by the claims and it is not intended that any limitations or elements described the exemplary embodiments set forth herein are to be incorporated into the interpretation of any claim element unless such limitation or element is explicitly stated. Likewise, it is to be understood that it is not necessary to meet any or all of the identified advantages disclosed herein in order to fall within the scope of any claims, as the invention is defined by the claims and inherent advantages of the invention may exist even though not explicitly discussed.

What is claimed is:

1. A fluid reservoir, comprising:
a body having a liquid compartment and a negative pressure inducing cavity separated by a partition, said negative pressure producing cavity including a negative pressure inducing material disposed in said cavity; and
a facade connected to said body.

2. The reservoir of claim 1, wherein said facade comprises a structure having a top, bottom and four side portions.

3. The reservoir of claim 2, wherein one of said side portions has a distinctive shape that corresponds to a shape of a receiving member of a printing device.

4. The reservoir of claim 3, wherein one of said side portions includes a tank mount rib configured to fit into a corresponding slot of a printer carrier.

5. The reservoir claim 2, further comprising a lid that extends across said body and encloses said liquid compartment and said negative pressure inducing cavity.

6. The reservoir of claim 5, wherein said lid includes an air vent and an inlet port.

7. The reservoir of claim 6, wherein said body includes a bottom wall, said bottom wall including a fluid outlet port and a member for detecting a presence of fluid in said liquid compartment.

8. The reservoir of claim 7, wherein said fluid outlet port is configured to receive a wick.

9. The reservoir of claim 2, wherein said top, bottom and four side portions create a cavity within said facade that is capable of receiving a RFID tag.

10. The reservoir of claim 9, wherein said facade cavity includes a tag support member adapted to receive at least a portion of a RFID tag.

11. An ink tank, comprising:
a body that includes at least one negative pressure inducing cavity, a facade cavity, and a partition disposed between said facade cavity and said negative pressure inducing cavity, and
a lid that extends across and covers said negative pressure inducing cavity, and said facade cavity.

12. The ink tank of claim 11, wherein said body includes a bottom and four side walls, and said bottom includes an ink outlet port disposed beneath said negative pressure inducing cavity.

13. The ink tank of claim 12, wherein said bottom also includes an ink presence structure disposed beneath said liquid compartment.

14. The ink tank of claim 13, wherein said at least one of said four side walls has a distinctive shape that corresponds to a shape of a receiving member of a printing device.

15. The ink tank of claim 12, wherein said facade cavity is disposed adjacent a side wall having a distinctive shape that corresponds to a shape of a receiving member of a printing device.

16. The ink tank of claim 11, further comprising a RFID tag disposed in said facade cavity.

17. A method of mounting a RFID tag into an ink tank, comprising:
inserting a RFID tag in a cavity of a facade; and
affixing said facade to said ink tank.

18. The method of claim 17, wherein inserting a RFID tag comprises inserting said RFID tag through a bottom of said facade cavity, said facade cavity having an interior ledge on which said RFID tag rests upon insertion.

19. The method of claim 17, wherein inserting said RFID tag comprises inserting said RFID tag through a top of said facade cavity into said facade cavity, and converting said cavity with a lid.

20. A fluid reservoir, comprising:
a body having a lid portion, a bottom portion and four side walls, said body defining a negative pressure inducing region and a facade region within said body; said lid portion extending across said negative pressure inducing region and said facade region, an air vent disposed in said lid such that said negative pressure inducing region is in fluid communication with ambient air;
a partition wall disposed in said body, said partition wall creating a fluidic seal between said negative pressure inducing region and said facade region; and
an outlet port disposed in said bottom portion adjacent said negative pressure inducing region.
